(19) United States
(12) Patent Application Publication
(10) Pub. No.: US 2010/0149437 A1
(43) Pub. Date: Jun. 17, 2010

(54) Portable Communication Device with Embedded Projector

(76) Inventor: Kuo-Ching CHIANG, Linkou Township (TW)

Correspondence Address: SINORICA, LLC, 2275 Research Blvd., Suite 500, ROCKVILLE, MD, 20850, US

(21) Appl. No.: 12/711,366

(22) Filed: Feb. 24, 2010

Related U.S. Application Data
(63) Continuation-in-part of application No. 11/701,158, filed on Jan. 31, 2007.
Application No. 11/701,158 is a continuation of application No. 10/989,622, filed on Nov. 15, 2004, now Pat. No. 7,178,735.
Application No. 10/989,622 is a continuation-in-part of application No. 11/783,551, filed on Apr. 10, 2007.

(51) Int. Cl. H04N 3/22

(52) U.S. Cl. 348/745; 348/E03.04

(57) ABSTRACT

The portable device comprises a control IC and a projection display module for the data projection. The portable communication device with embedded projector includes a RF module embedded in the portable communication device for wireless vocal communication; a built-in display embedded in the portable communication device for display; wherein the portable communication device comprises: a control IC; red, green and blue illuminations coupled to the control IC to illuminate a pre-determined light, respectively; a color combiner coupled to the red, green and blue illuminations, wherein the red, green and blue illuminations respectively positioned corresponding to the color combiner which is introduced to combine illuminations from the red, green and blue illuminations for each display color combination; and two-dimension reflector coupled to the color combiner to reflect a pre-determined color illumination on a pre-determined location defined by the control IC to enlarge projection image.

The application is a continuous in part application of Ser. No. 11/701,158, filed on Jan. 31, 2007, which is a continuation application of U.S. Pat. No. 7,178,735, filed on Nov. 15, 2004, and is a continuation in part application of Ser. No. 11/783,551, filed on Apr. 10, 2007.

### FIELD OF THE INVENTION

The present invention relates generally to a portable terminal and more particularly to a portable device with embedded projector

### BACKGROUND OF THE INVENTION

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone.

Recently, the price of cellular telephone has been greatly reduced and become affordable to lots of people. It is common that a person owns more than one cellular phone. Some people even replace their cellular telephones as often as they replace their clothes or hairstyle. The cellular manufactures have to release new models with different appearances, function and styles more frequently so as to attract the attention of the buyer and occupy a favorable marketing share. Furthermore, the conventional projector employ white light lamp as a light source, therefore, at least two reflector lens and at least three light-split lens are required to split the white light into three colors (red, green and blue). The optical lens set is expensive. The mechanism of the optical system is too complicated and the size can not be reduced. Further, the lamp source will generate heat with high temperature.

### SUMMARY OF THE INVENTION

The object of the present invention is to provide a projector with panel form light source.

The portable device comprises a control IC and a projection display module for the data projection. The portable communication device with embedded projector includes a RF module embedded in the portable communication device for wireless vocal communication; a built-in display embedded in the portable communication device for display; wherein the portable communication device comprises: a control IC; red, green and blue illuminations coupled to the control IC to illuminate a pre-determined light, respectively; a color combiner coupled to the red, green and blue illuminations, wherein the red, green and blue illuminations respectively positioned corresponding to the color combiner which is introduced to combine illuminations from the red, green and blue illuminations for each display color combination; and two-dimension reflector coupled to the color combiner to reflect a pre-determined color illumination on a pre-determined location defined by the control IC to enlarge projection image.

A portable device comprises a central control IC imbedded in said portable device; a RF module coupled to the control IC for wireless communication and a display, memory and an input unit coupled to the control IC. A pinhole camera detector embedded in said portable device, said pinhole camera detector is sensitive to a transmittance frequency from about 300 MHz to 2.5 GHz.

A further aspect of the present invention is to disclose a portable device comprising a control IC imbedded in the portable device; a RF module coupled to the control IC for wireless communication; a display, memory and an input unit coupled to the control IC; and a remote control module coupled to said central control IC to control lock or a device by the key code coded in the memory.

Anther embodiment of the present invention comprises a control IC imbedded in a portable device; a RF module coupled to the control IC for wireless communication; a display, memory and an input unit coupled to the control IC; and an alcohol ingredients detecting module is provided and coupled to the control IC to detect alcohol containment.

In order to achieve the object of the present invention, a portable device comprises a control IC imbedded in the portable device; a RF module coupled to the control IC for wireless communication; a display, memory and an input unit coupled to the control IC; and an illumination source embedded in the portable device for acting as pointer or flashlight. The illumination source includes a laser component. Wherein the illumination source include a lamp (or LED) and a reflector position in accordance with the lamp to reflect light generated by the lamp.

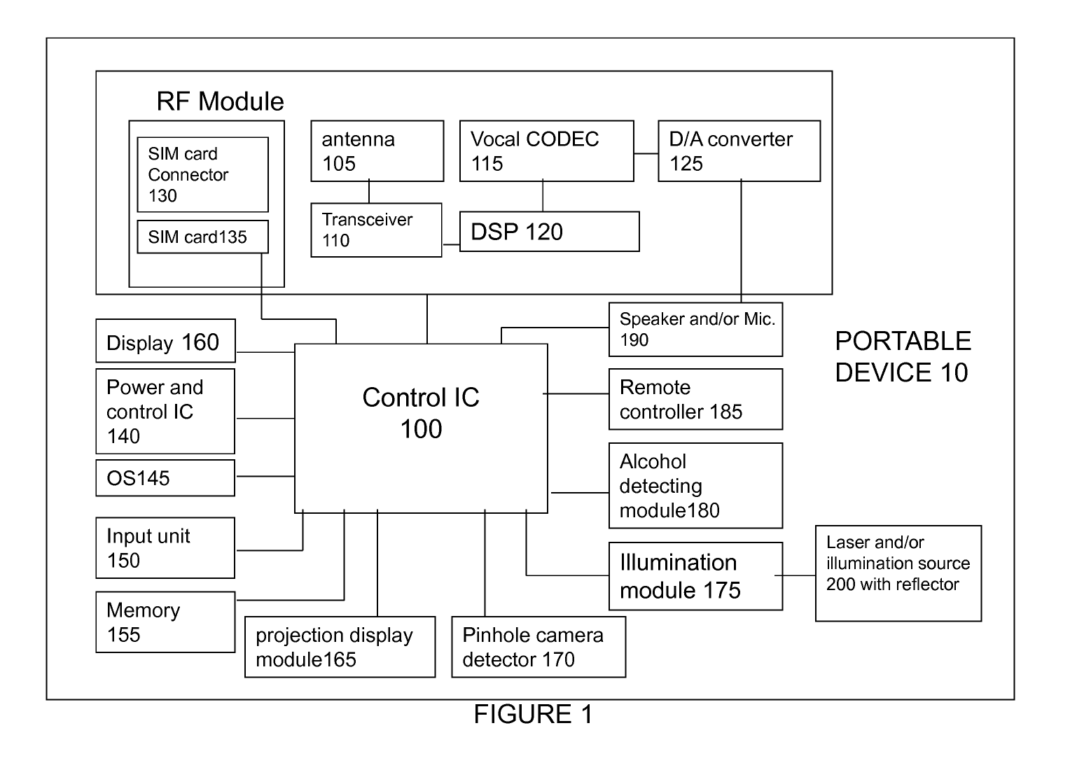

FIG. 1 shows a diagram of a cellular terminal according to the present invention.

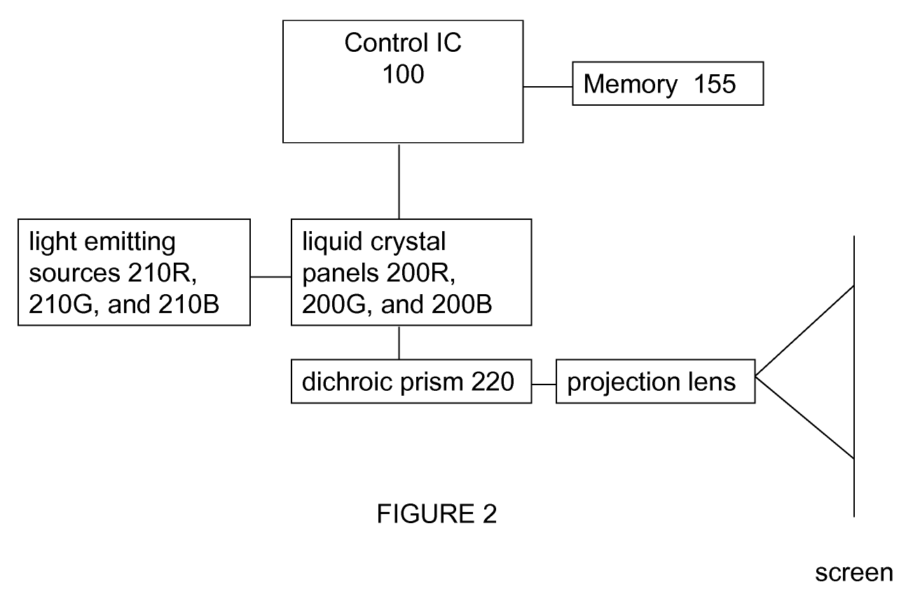

FIG. 2 shows a diagram of a projection display module according to the present invention.

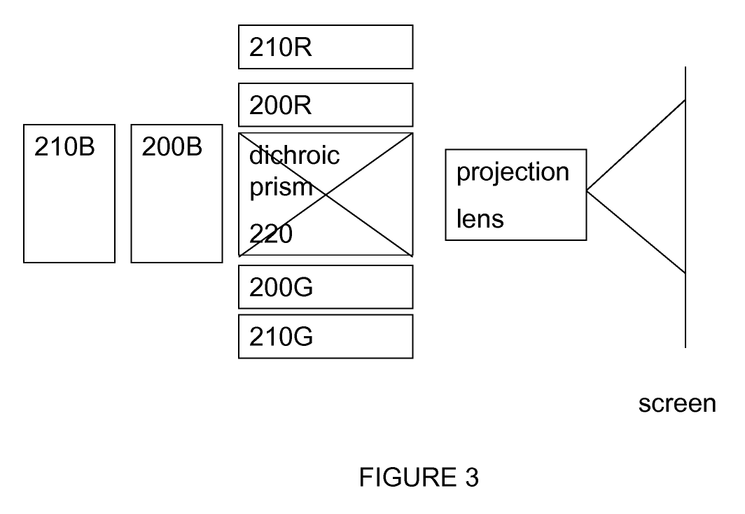

FIG. 3 shows a diagram of a projection display module according to the present invention.

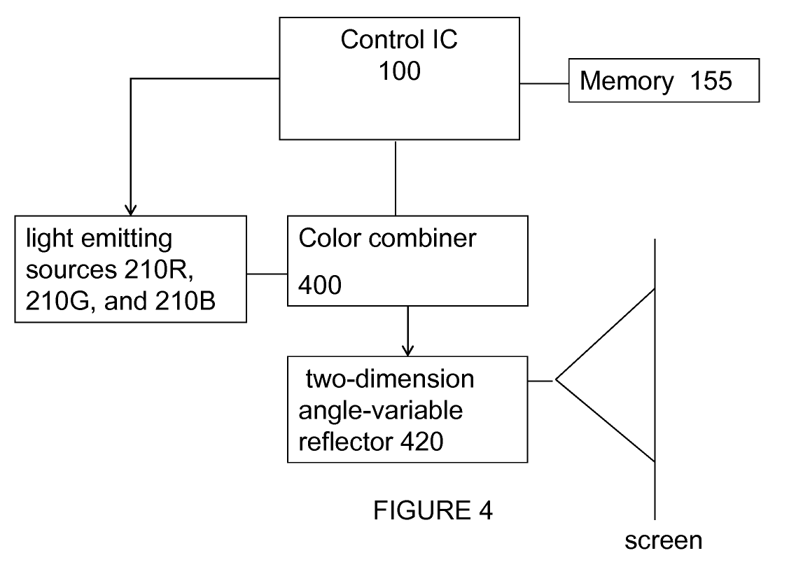

FIG. 4-6 show diagrams of a projection display module according to the present invention.

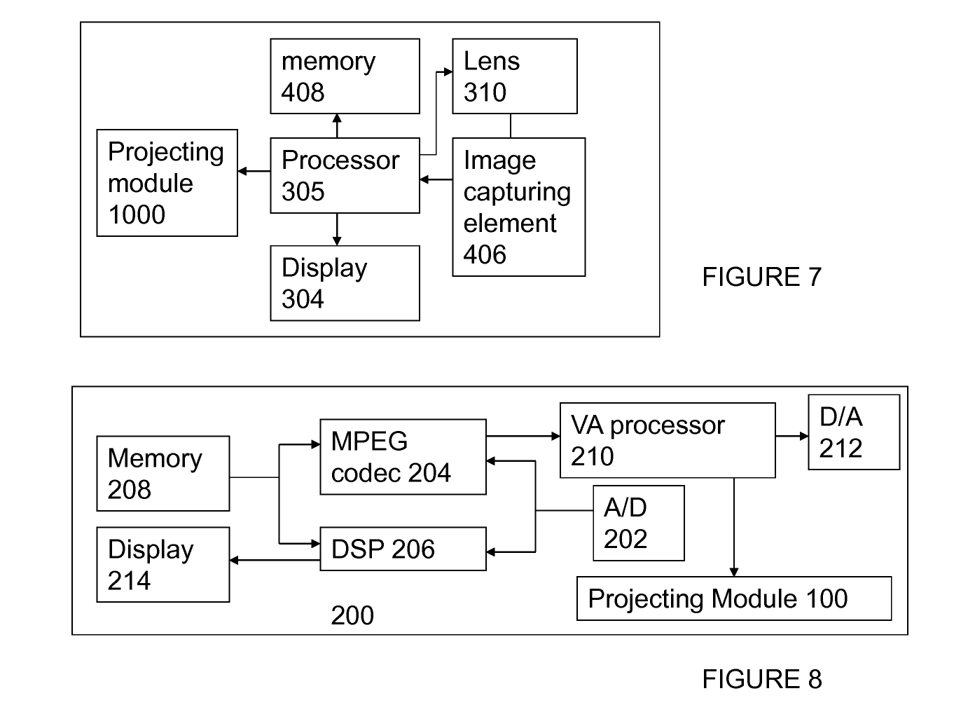

FIG. 7-8 show diagrams of a media player and digital camera with the projection display module according to the present invention.

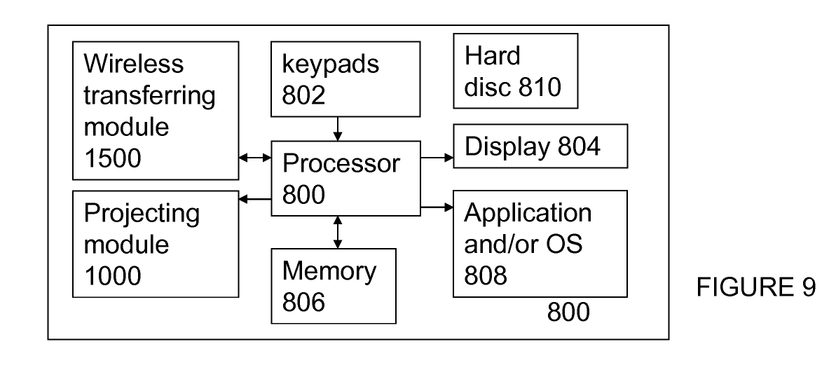

FIG. 9 shows a diagram of a notebook with the projection display module according to the present invention.

### DETAILED DESCRIPTION

The present invention relates generally to a multi-function portable terminal. The portable terminal includes but not limited to cellular phone, PDA (personal digital assistant), smart phone, digital camera and notebook and the equivalent thereof.

FIG. 1 shows a block diagram of a portable terminal with SIM card connector 130 to carry the SIM card 135, it is well know in the art, the SIM card is not necessary for some other type of cellular such as PHS system. The diagram is used for illustrating and not used for limiting the scope of the present invention. The portable terminal or device 10 includes a RF module. As know in the art, the RF module includes antenna 105. This antenna 105 is connected to a transceiver 110, which is used to receive and transmit signal. AS know, the RF module further includes CODEC 115, DSP 120 and A/D converter as well. Due to the RF module is not the feature of the present invention, therefore, the detailed description is omitted. The present invention includes a central control IC 100, an input unit 150, a build-in display 160, OS 145, power and control IC 140 and memory 155 including a ROM program memory, a RAM memory and a nonvolatile FLASH memory. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 190.

The present invention includes one or more following module that is not disclosed by the current cellular terminal. It should be noted that the additional module can be implanted along or combination depending on the necessary.

A pinhole camera detector 170 indicates the addition of a device, which is apt to wireless or wired signal. The pinhole camera detector is sensitive to the transmittance frequency, for example, from the 300 MHz to 2.5 GHz, and is coupled to the control IC 100. The detector also includes a switch coupled to pinhole camera detector to active the detector. As known, the pinhole video camera includes a printed circuit board, a charged coupled device (hereinafter referred to as “CCD”), memory means for storing a single frame image which is generated by image signal from the CCD and a signal converting means, a connector with wires to connect the aforementioned circuits to power source and the displayer. A conical convex lens is accommodated to have an apical angle and the apex is fixed so as to face the pinhole. The pinhole camera detector 120 is available to scan and detect the operation frequency while the pinhole camera is in function. The so-called spy camera could also be detected by the pinhole camera detector 120 as well. The scanned result can be send to the display 160 and/or the loudspeaker and a microphone 190, thereby sending an alarm signal.

Moreover, the portable terminal according to the present invention shown in FIG. 1 has another function module. An embodiment is now described with reference to FIGS. 2. A projection display module 165 is coupled to the control IC 100. One type of such a projection display module 165 that is known is the liquid crystal projector wherewith images on a liquid crystal panel are enlarged and projected by a projection lens onto a reflective screen and thus displayed. The liquid crystal projection display module comprises a light source lamp unit inside a shell of the device. Electrical discharge lamps such as metal halide lamps, or halogen lamps, could be used in the light source lamp unit. The light emitted from this light source lamp unit is guided via a mirror to dichroic mirrors, whereby it is separated into red light, green light, and blue light. The images displayed on the three liquid crystal panels, respectively, are illuminated by their respective colors, and this light is combined by a dichroic prism.

In preferable embodiment, please refer to FIG. 3, the liquid crystal projector comprises three liquid crystal panels 200R, 200G, and 200B that perform image displays in red, green, and blue, respectively. Preferably, panel-form light emitting sources 210R, 210G, and 210B is employed and positioned in correspondence with the liquid crystal panels, respectively. In one embodiment, the light emitting sources 210R, 210G, and 210B are organic EL (electroluminescence) elements. These organic EL elements are electric-field light emitting thin films that capable of emission of red, green, and blue light. The EL elements are formed behind and adjacent to the liquid crystal panels 200R, 2000, and 200B, respectively. The liquid crystal panels 200R, 200G, and 200B and the light sources 210R, 210G, and 210B are positioned on the light-incidence side of the side surfaces of the dichroic prism 220 for each display color combination. The projection lens 230 could be made up of a plurality of lenses. Thus, the data or file stored in the memory of the device can be projected on a screen or wall. It allows the user to project the image, game or file on an external screen. The EL element is small, flat form, light weight, therefore, it allows the small projection to be integrated in the portable device.

A further aspect of the present invention is that the device 10 also includes remote control module 185. The remote control module 185 maybe used to control lock or device by the key code coded in the remote control module 185. The remote controller is also a mature technology. Remote controllers for electrical and electronic appliances are well known, and are widely used. In one example, the remote control module 185 applies infrared rays for transmission, and each company provides its appliances and remote controllers with its specific protocol of communication. An example of the remote control module 185 is provided with an interface for downloading the relevant information into the remote control module 185 from an external source. In one embodiment of remote controller is provided with an infrared transmitter for sending remote controlling signals to the appliance. The remote controller is provided with a RAM or ROM, or EPROM, or EEPROM internal database (memory 155) to which set-up information regarding the key-map and signal format of at least one apparatus to be controlled is entered. Such information can be commonly provided to the internal database from various sources, such as from a smart card, from an Internet database, from a plugged-in card, etc. The database in the appliance contains set-up data that can be transmitted by transmitter to the remote control module 185 providing it all the information it needs in order to control the appliance. The present invention uses the RF module to download the key code from database through network.

Another aspect of the present invention is that the portable device 10 also includes an alcohol detecting module 180.The alcohol ingredients detecting module 180 is provided and coupled to the control IC 100 to detect the alcohol ingredients from one's breath, for example, the module is capable of detecting alcohol content. The alcohol detecting module 180 is sensitive to the aforementioned alcohol content. If the bonding is detected, the signal will be send from the alcohol detecting module 180 to the control IC 100 for determine the level of the alcohol ingredients. Then, the result will be send to the display 160. U.S. Pat. No. 5,907,407 had disclosed various methods to detecting the alcohol. U.S. Pat. No. 4,809,810 disclosed a system both apparatus and method, for analyzing a breath sample.

Further, an illumination module 175 is also employed by the present invention. The portable device could be used as a laser pointer if the illumination module 175 includes a laser component 200. A switch can be provided to active the laser. In another embodiment, the illumination module 175 includes a light source to allow the portable device to be used as the flashlight. Especially, one may turn on the illumination module 175 in dark environment such as in a theater. The illumination module 175 could be coupled to the control IC 100 or implanted with an independent control IC. The illumination source includes a laser component. Wherein the illumination source include a lamp (or LED) and a reflector position in accordance with the lamp to reflect light generated by the lamp. The aforementioned laser devices or LED could be user for the projector as the aforementioned panel-form light sources as well.

An embodiment is now described with reference to FIGS. 4. Pluralities of illuminations 210R, 210G, 210B are coupled to the control IC 100. The control IC will sent a image control signal to the pluralities of illuminations 210R, 210G, 210B, respectively. The pluralities of illuminations 210R, 210G, 210B are all independent light sources, such as LED, OLED or Laser. The images will be enlarged and projected by two-dimension reflector onto a reflective screen and thus displayed. A color combiner (or illuminator combiner) 400 will receive the illumination from each of the pluralities of illuminations 210R, 210G, 210B, thereby constructing a demanded color which is determined by the control IC 100. The color combiner (or illuminator combiner) 400 can mix any color via the R, G, B illumination sources at any timing controlled by the control IC 100. A two-dimension angle-variable reflector 420 is coupled to the color combiner (or illuminator combiner) 400 to reflect the combined illumination to a pre-determined location on the screen. The two-dimension angle-variable reflector 420 may change the angle between the normal line of the screen and the reflected beam. Preferably, the two-dimension reflector 420 is made by thin membrane which can reflect illumination along the X and Y axis to show the image pixel-by pixel. It can be made by digital mirror technology or micro electro mechanical systems. The illuminations includes a laser, LED, or OLED to emit a laser beam to the two dimension reflector for horizontally moving the laser beam at a first sweep frequency along X-axis, and vertically moving the laser beam up or down along Y-axis. The control IC is operative for controlling two-dimension reflector to insure the pixel of the image can be reflected to a demanded location. A driver of the two-dimension reflector drives the angle of the two-dimension reflector. The driver horizontally sweeps X-direction to form a horizontal scan line from one point, then the drive adjusts the angle to move scan line to next vertical position, followed by sweeping another X-direction to form a second horizontal scan line along the X-direction to form a second scan line. The formation of successive scan lines proceeds in the same manner. The whole image can be scanned by one two dimension reflector and can be made by digital mirror technology or micro electro mechanical systems. The projection image can be displayed by the two dimension reflector.

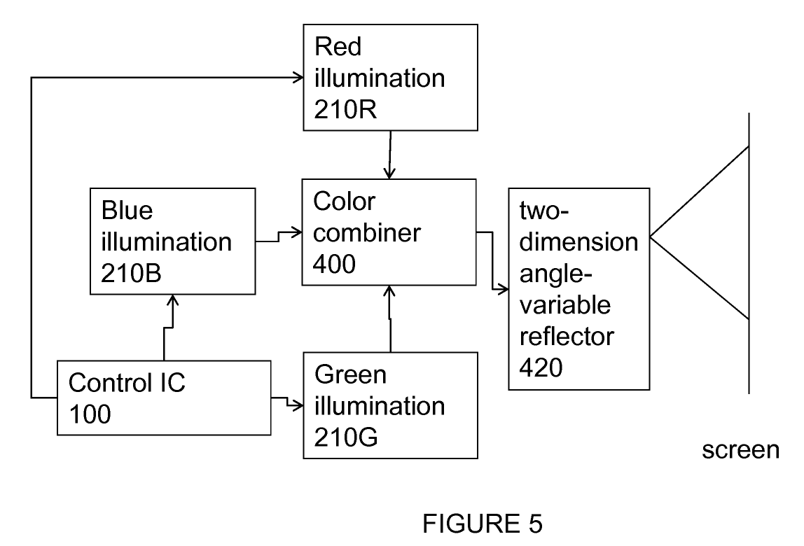

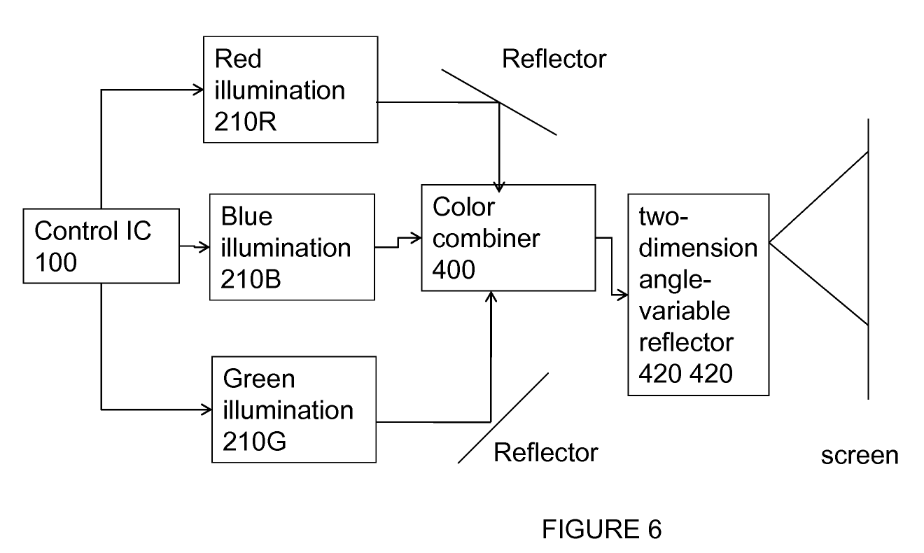

In preferable embodiment, please refer to FIG. 5, light emitting sources 210R, 210G, and 210B is employed and positioned in correspondence with the color combiner 400, respectively. In one embodiment, the light emitting sources 210R, 210G, and 210B are organic EL (electroluminescence) elements, LED or Laser. These organic EL elements are electric-field light emitting thin films that capable of emission of red, green, and blue light. The EL elements are formed adjacent to the color combiner 400, respectively. The light sources 210R, 210G, and 210B are positioned on the three sides of the color combiner 400 for each display color combination. Thus, the data or file stored in the memory of the device can be projected on a screen or wall. It allows the user to project the image, game or file on an external screen. The EL element is small, flat form, light weight, therefore, it allows the small projection to be integrated in the portable device. FIG. 6 shows that the light emitting sources 210R, 210G, and 210B are reflected by a reflector into the color combiner 400, and thereby projecting by the two-dimension reflector 420.

Further, referring to FIG. 7, the device includes a main body having a process 402; a display 404 formed on the main body and coupled to the processor 402; an image capture element 406 formed within the main body and coupled to the processor 402; a memory 408 coupled to the processor; a lens mechanism 310 formed on the main body, coupled to the processor 402 and corresponding to the image capture element 406; the projecting module 1000 is coupled processor of the portable device so as to project the captured image on a screen. The projecting module 1000 is disclosed from above preferred embodiment alone or combination.

If the projecting module 1000 is employed for medium player such as MP3 player, MP4 player, the player includes an analog/digital (A/D) converter 202 for converting analog audio signals into digital audio signals. The analog audio signals can come from an audio source coupled to player 200. A digital signal processor (DSP) 204 or an audio and/or video driving module 206, for instance MP3, MP4 codec, are coupled to A/D converter 202 to receive the digital audio signals. In one embodiment, MP3 or MP4 codec 206 executes a firmware that includes a MPEG audio layer (e.g., MP3, MP2, or both) codec or video codec (e.g., MP4), and DSP 204 executes a firmware that includes a different type of audio codec (e.g., WMA, ACC, or both). In one embodiment, the firmware for DSP 204 also includes a video codec for encoding and decoding videos (e.g., MPEG-4 V1/V2/V3, DivX 3.11/4.0/5.0, Xvid, AVI/ASF, or any combination thereof). MP3 (or MP4) codec 206 and DSP 204 are coupled to a nonvolatile memory 208 that stores the compressed audio data. The user can select an audio file from nonvolatile memory 208. DSPs 204 and 206 are coupled to an audio processor 210, which processes the digital audio signals according to default settings or user instructions. Audio processor 210 is coupled to a digital/analog (D/A) converter 212, which converts the digital audio signals into analog audio signals for the user. A display 214 is coupled to the DSP 206. The projecting module 1000 is disclosed from above preferred embodiment alone or combination.

As shown in FIG. 8, wherein the projecting module 1000 can be integrated into the portable computer system comprises: a processor 800 formed within the portable device; a keypad 802 formed on the portable device; a display 804 coupled the processor; a memory 806 coupled to said processor 800. The device further includes an application and/or OS 808 and hard disc 810 coupled to the processor. It further includes the WLAN module 1500 and the projecting module 1000. Similarity, the present invention can be used in electronic book.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

1. A portable communication device with embedded projector, a RF module embedded in said portable communication device for wireless vocal communication; a built-in display embedded in said portable communication device for display; wherein said portable communication device comprises:
a control IC;
red, green and blue illuminations coupled to the control IC to illuminate a pre-determined light, respectively;
a color combiner coupled to said red, green and blue illuminations, wherein said red, green and blue illuminations respectively positioned corresponding to said color combiner which is introduced to combine illuminations from said red, green and blue illuminations for each display color combination; and
two-dimension reflector coupled to said color combiner to reflect a pre-determined color illumination on a pre-determined location defined by said control IC to enlarge projection image.

2. The portable communication device of claim 1, furthering comprising a remote data transferring module with communication protocol for wirelessly downloading information from an external source to said projector.

3. The portable communication device of claim 1, wherein said red, green and blue illuminations include lasers.

4. The portable communication device of claim 1, wherein said red, green and blue illuminations include LEDs.

5. The portable communication device of claim 1, wherein said red, green and blue illuminations include OLEDs.
